(19) United States
(12) Patent Application Publication
(10) Pub. No.: US 2026/0008445 A1
(43) Pub. Date: Jan. 8, 2026

(54) ELECTRIC BRAKING DEVICE

(71) Applicant: ADVICS CO., LTD., Kariya-shi, Aichi-ken (JP)

(72) Inventor: Takayuki WAZAKI, Kariya-shi, Aichi-ken (JP)

(73) Assignee: ADVICS CO., LTD., Kariya-shi, Aichi-ken (JP)

(21) Appl. No.: 19/111,239

(22) PCT Filed: Sep. 28, 2023
(86) PCT No.: PCT/JP2023/035466

§ 371 Date: Mar. 12, 2025

(30) Foreign Application Priority Data
Sep. 30, 2022 (JP) 2022-157851

(51) Int. Cl. B60T 13/74; F16D 65/18

(52) U.S. Cl. CPC B60T 13/74; F16D 65/18

(57) ABSTRACT

Between a nut of a linear-motion converting mechanism that converts rotation of an electric motor into linear motion and a piston is interposed a connecting member that mediates transmission of pressing force between the nut and the piston. The nut is installed to be pivotable with respect to the connecting member, and the connecting member is installed to be radially movable with respect to the piston.

### TECHNICAL FIELD

The present disclosure relates to an electric braking device.

### BACKGROUND ART

As an electric braking device, a device described in Patent Literature 1 is known. The electric braking device in Patent Literature 1 includes an electric motor, a linear-motion converting mechanism, and a piston. The linear-motion converting mechanism includes a rotary member rotated by the electric motor, and a linear motion member that linearly moves according to rotation of the rotary member. A pressing element is interposed between the linear motion member of the linear-motion converting mechanism and the piston. At least one of the piston and the pressing element is formed in an arc shape. The piston and the pressing element are in contact with each other at the arc-shaped portion. In such an electric braking device, pivoting of the pressing element with respect to the piston is allowed. Through the pivoting, bending deformation of the constituent members and increase in sliding resistance of the piston with respect to the cylinder due to deflection of the cylinder or the like at the time of generation of the braking force are suppressed.

### CITATIONS LIST

### Patent Literature

Patent Literature 1: Japanese Patent Application Laid-Open No. 2020-193641

### SUMMARY

### Technical Problems

Depending on how the cylinder or the like is distorted at the time of generation of the braking force, bending deformation and an increase in sliding resistance due to distortion may not be sufficiently suppressed only by the pivoting of the pressing element with respect to the piston.

### Solutions to Problems

An electric braking device for solving the above problem includes a piston linearly movably accommodated in a cylinder, and configured to generate a braking force of a wheel according to linear motion of the piston having rotation of an electric motor as power. In addition, the electric braking device includes a linear-motion converting mechanism including a rotary member configured to rotate upon receiving rotation of the electric motor and a linear motion member configured to linearly move according to rotation of the rotary member; and a connecting member interposed between the linear motion member and the piston to mediate transmission of a pressing force in an axial direction of the cylinder between the linear motion member and the piston. The linear motion member in the electric braking device is installed to be pivotable with respect to the connecting member, and the connecting member is installed to be movable in a radial direction of the cylinder with respect to the piston.

There is a case where the center axis of the cylinder is inclined with respect to the center axis of the piston due to deflection of components of the electric braking device, and a machining error or an assembly error at the time of manufacturing. In addition to the center axis of the cylinder, the rotation axis of the rotary member of the linear-motion converting mechanism may also be inclined from the center axis of the piston, and an unbalanced load may be generated in the components of the electric braking device. Such an unbalanced load causes uneven wear and bending deformation of the component.

In the electric braking device, pivoting of the linear motion member with respect to the connecting member and movement of the connecting member in the radial direction with respect to the piston are permitted. In such an electric braking device, it is possible to maintain a state in which the center axis of the cylinder inclined with respect to the center axis of the piston and the rotation axis of the rotary member coincide with each other regardless of the position of the piston in the cylinder. Therefore, the electric braking device has an effect of suppressing the generation of an unbalanced load of the component due to the inclination of the center axis of the piston with respect to the cylinder.

### BRIEF DESCRIPTION OF DRAWINGS

FIG. 1 is a diagram schematically illustrating a cross-sectional structure of an embodiment of an electric braking device.

FIG. 2 is a cross-sectional view of a piston, a connecting member, and a linear-motion converting mechanism of the electric braking device.

FIG. 3 is a diagram illustrating a perspective structure of the connecting member and a linear motion member of the electric braking device.

FIG. 4 is a cross-sectional view illustrating a state at the time of generation of a braking force of the piston, the connecting member, and the linear-motion converting mechanism of the electric braking device.

FIG. 5 is a cross-sectional view illustrating a state at the time of generation of a braking force of the piston, the connecting member, and the linear-motion converting mechanism of the electric braking device when wear of a friction member has progressed more than in the case of FIG. 4.

FIG. 6 is a side view of a connecting member and a nut in a modified example of the electric braking device.

FIG. 7 is a cross-sectional view of the connecting member and the nut in the modified example of the electric braking device.

### DESCRIPTION OF EMBODIMENTS

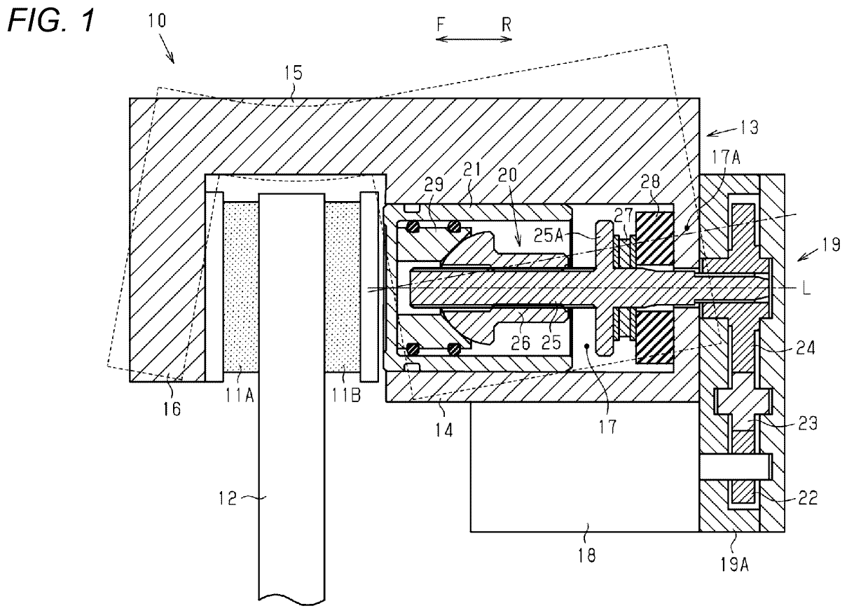

Hereinafter, an embodiment of an electric braking device will be described with reference to FIGS. 1 to 5.

### <Overall Configuration of Electric Braking Device>

First, an overall configuration of an electric braking device 10 of the present embodiment will be described with reference to FIG. 1. The electric braking device 10 of the present embodiment is configured as a caliper type disc brake device that brakes the rotation of a disc rotor 12 by clamping the disc rotor 12 with two friction members 11A and 11B.

The electric braking device 10 includes a caliper 13. The caliper 13 includes a cylinder body 14, a bridge portion 15, and a claw portion 16. The cylinder body 14 and the claw portion 16 are disposed so as to sandwich the disc rotor 12 therebetween. The bridge portion 15 is a portion coupling the cylinder body 14 and the claw portion 16 in the caliper 13, and is disposed on the radially outer side than the disc rotor 12. Note that one (11A) of the two friction members 11A and 11B is assembled to the claw portion 16, and the other one (11B) is assembled to the cylinder body 14. Furthermore, the cylinder body 14 is provided with a cylinder 17. The cylinder 17 is a bottomed cylindrical hole opened on the side on which the disc rotor 12 is located when viewed from the cylinder body 14.

Furthermore, the electric braking device 10 includes an electric motor 18, a speed reducing mechanism 19, a linear-motion converting mechanism 20, and a piston 21. The electric motor 18 is assembled to the cylinder body 14. The speed reducing mechanism 19 is accommodated inside a gear box 19A assembled to the cylinder body 14. The linear-motion converting mechanism 20 and the piston 21 are accommodated in the cylinder 17 of the cylinder body 14.

The speed reducing mechanism 19 is a mechanism that decelerates the rotation of the electric motor 18 and transmits the rotation to the linear-motion converting mechanism 20. In the case of the electric braking device 10 of the present embodiment, a speed reduction gear mechanism having a plurality of gears is used as the speed reducing mechanism 19. The speed reducing mechanism 19 illustrated in FIG. 1 includes a first gear 22 coupled to the electric motor 18, a third gear 24 coupled to the linear-motion converting mechanism 20, and a second gear 23 interposed between the first gear 22 and the third gear 24.

The linear-motion converting mechanism 20 is a mechanism that converts the rotation transmitted from the speed reducing mechanism 19 into a linear motion. In the case of the electric braking device 10 of the present embodiment, a screw shaft 25 serving as a rotary member that rotates in response to the rotation of the electric motor 18, and a nut 26 serving as a linear motion member that linearly moves in accordance with the rotation of the screw shaft 25 are provided. The screw shaft 25 is connected to the third gear 24 of the speed reducing mechanism 19 so as to rotate integrally. Note that the linear-motion converting mechanism 20 is installed such that the rotation axis of the screw shaft 25 is coaxial with the center axis L of the cylinder 17.

The piston 21 is installed in the cylinder 17 so as to be linearly movable in the axial direction. In the following description, in the axial direction of the cylinder 17, the side on which the friction member 11B is located when viewed from the piston 21 is referred to as an axial front side F, and the opposite side is referred to as an axial rear side R.

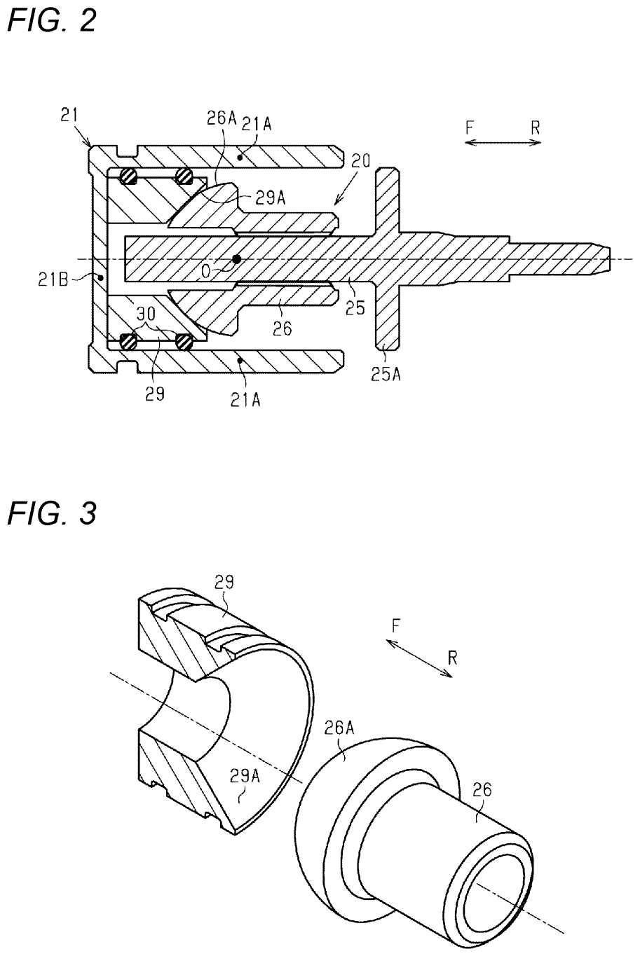

As illustrated in FIG. 2, the piston 21 has a bottomed cylindrical shape opened to the axial rear side R, and includes a side peripheral wall 21A having a circular tube shape and a bottom wall 21B having a disc shape. In a portion that has become a space surrounded by the side peripheral wall 21A of the piston 21, a connecting member 29 is installed in a state of being in contact with the bottom wall 21B. The connecting member 29 is a member that is interposed between the nut 26 and the piston 21 and mediates transmission of pressing force in the axial direction of the cylinder 17 therebetween. Details of the connection structure of the piston 21 and the nut 26 via the connecting member 29 will be described later.

Note that as illustrated in FIG. 1, a flange portion 25A having an enlarged diameter is provided at a portion on the axial rear side R than a portion where the nut 26 is meshed in the screw shaft 25. A thrust bearing 27 and the pressure sensor 28 are installed inside the cylinder 17 while being sandwiched between the bottom wall 17A of the cylinder 17 and the flange portion 25A of the screw shaft 25.

When the electric motor 18 rotates, the rotation is decelerated by the speed reducing mechanism 19 and transmitted to the screw shaft 25 of the linear-motion converting mechanism 20. Then, the linear-motion converting mechanism 20 converts the rotation of the screw shaft 25 into the linear motion of the nut 26. When the nut 26 moves toward the axial front side F until coming into contact with the connecting member 29, pressing force toward the axial front side F is applied to the piston 21 via the connecting member 29. Then, the pressing force is transmitted to the friction member 11B via the piston 21. Thus, the electric braking device 10 generates the braking force by the friction members 11A and 11B clamping the disc rotor 12. Note that a reaction force against the pressing force is applied to the pressure sensor 28 when the piston 21 is applying the pressing force to the friction member 11B via the flange portion 25A of the screw shaft 25. Therefore, the output signal of the pressure sensor 28 is a signal corresponding to the braking force generated by the electric braking device 10.

### <Connection Structure of Piston 21 and Nut 26>

Next, a connection structure of the piston 21 and the nut 26 will be described with reference to FIGS. 2 and 3. FIG. 2 illustrates a cross-sectional structure of the piston 21, the connecting member 29, and the linear-motion converting mechanism 20 of the electric braking device 10. Furthermore, FIG. 3 illustrates an exploded perspective structure of the connecting member 29 and the nut 26.

The connecting member 29 has an annular columnar shape. Furthermore, at an end portion on the axial rear side R, the connecting member 29 has a tapered portion 29A which is a conical tapered recessed portion. On the other hand, at an end portion on the axial front side F, the nut 26 has a spherical curved surface portion 26A having a center on the rotation axis of the screw shaft 25. The connecting member 29 and the nut 26 are in contact through line contact of the curved surface portion 26A with respect to the tapered portion 29A. Therefore, the connecting member 29 can pivot with two degrees of freedom with respect to the nut 26 in a state where the pressing force from the nut 26 at the time of generation of the braking force is applied.

Furthermore, an elastic member 30 such as an O-ring is interposed at a portion between the connecting member 29 and the side peripheral wall 21A of the piston 21 in the radial direction of the cylinder 17. Therefore, the connecting member 29 can move in the radial direction of the piston 21 by the elastic deformation of the elastic member 30 with respect to the piston 21.

Note that in the present embodiment, as the material of the piston 21, a material having lower strength but lighter specific gravity than the material of the connecting member 29 is used. For example, an example of a material of the piston 21 is an aluminum material, and an example of a material of the connecting member 29 is a steel material.

### Operations and Effects of Embodiment

Operations and effects of the present embodiment will be described.

The electric braking device 10 generates braking force by clamping the disc rotor 12 by the friction member 11A assembled to the claw portion 16 and the friction member 11B assembled to the cylinder body 14. At the time of generation of such a braking force, a reaction force against the pressing force of the friction members 11A and 11B is applied to the claw portion 16 and the cylinder body 14. On the other hand, the claw portion 16 and the cylinder body 14 are connected by a bridge portion 15 located at a portion on the radially outer side than the disc rotor 12. Therefore, when a reaction force against pressing force is applied from the friction members 11A and 11B, deflection occurs in the caliper 13. Due to such a deflection, the center axis L of the cylinder 17 is inclined from the position before the occurrence of the deflection. Note that in FIG. 1, a state of deflection of the caliper 13 at the time of generation of the braking force is shown in an exaggerated manner with a dotted line.

The piston 21 at the time of generation of the braking force applies pressing force on the friction member 11B. Therefore, even if deflection occurs in the caliper 13, the posture of the piston 21 is maintained following the pressed surface of the friction member 11B. On the other hand, when the center axis L of the cylinder 17 is inclined due to the deflection of the caliper 13, the posture of the linear-motion converting mechanism 20 changes accordingly. Therefore, at the time of generation of the braking force, the rotation axis of the screw shaft 25 may be inclined with respect to the center axis of the piston 21. At this time, if the piston 21 and the nut 26 are rigidly fixed, an unbalanced load is applied to the piston 21, the linear-motion converting mechanism 20, and the like. Such an unbalanced load causes uneven wear of the cylinder 17 and the piston 21 and bending deformation of the screw shaft 25.

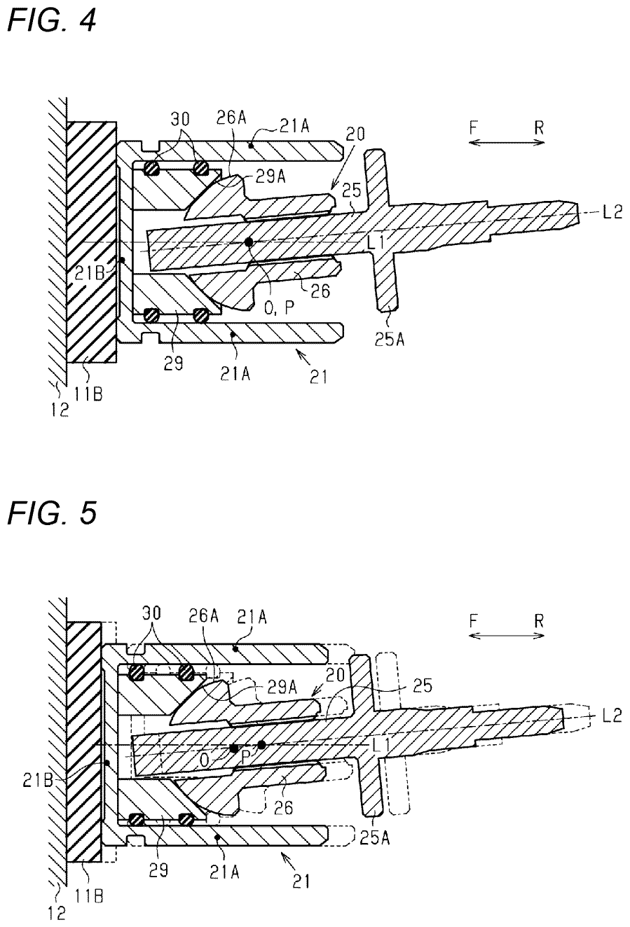

FIG. 4 illustrates a state at the time of generation of the braking force of the piston 21, the connecting member 29, and the linear-motion converting mechanism 20. In the case of FIG. 4, a center axis L2 of the cylinder 17 is inclined with respect to a center axis L1 of the piston 21. Even in such a case, if the linear-motion converting mechanism 20 is pivoted with respect to the piston 21 about the intersection point P of both center axes L1 and L2, a state in which the rotation axis of the screw shaft 25 is coaxial with the center axis L2 of the cylinder 17 can be maintained, and hence generation of an unbalanced load is suppressed. In the case of the present embodiment, the linear-motion converting mechanism 20 is installed in the cylinder 17 in a state where the nut 26 is permitted to pivot with respect to the connecting member 29. The position of the pivot center O of the nut 26 with respect to the connecting member 29 is the center of a sphere of the spherical curved surface constituting the curved surface portion 26A. Therefore, when the position of the pivot center O coincides with the position of the intersection point P between both center axes L1 and L2, the generation of an unbalanced load at the time of generation of the braking force is suppressed.

FIG. 5 illustrates a state at the time of occurrence of braking when the wear of the friction member 11B has progressed more than in the case of FIG. 4. When the friction member 11B is worn, the position of the piston 21 at the time of generation of the braking force approaches the disc rotor 12 accordingly. The position of the connecting member 29 changes together with the piston 21. Therefore, the position of the pivot center O of the nut 26 in the case of FIG. 5 is a position closer to the disc rotor 12 than in the case of FIG. 4. Therefore, in this case, the position of the pivot center O of the nut 26 becomes a position shifted in the axial direction of the cylinder 17 with respect to the intersection point P of both center axes L1 and L2. Therefore, if the linear-motion converting mechanism 20 is merely pivotable with respect to the piston 21, the generation of an unbalanced load at the time of generation of the braking force cannot be sufficiently suppressed due to the wear of the friction member 11B.

On the other hand, in the electric braking device 10 of the present embodiment, the connecting member 29 is installed in a state of being permitted to move in the radial direction with respect to the piston 21. Therefore, the position of the pivot center O of the nut 26 can be moved in the radial direction of the piston 21. Therefore, in the case of FIG. 5 as well, a state in which the rotation axis of the screw shaft 25 is coaxial with the center axis L2 of the cylinder 17 can be maintained by the radial movement of the connecting member 29 with respect to the piston 21 and the pivoting of the nut 26 with respect to the connecting member 29. As described above, the electric braking device 10 of the present embodiment has an effect of suppressing generation of an unbalanced load on the components when the center axes L1 and L2 of the piston 21 and the cylinder 17 are inclined.

In addition, the electric braking device 10 of the present embodiment includes an elastic member 30 interposed at a portion between the connecting member 29 and the piston 21 in the radial direction of the cylinder 17. The elastic member 30 permits the connecting member 29 to move in the radial direction with respect to the piston 21 by its elastic deformation. On the other hand, the elastic member 30 holds the connecting member 29 on the side peripheral wall 21A of the piston 21. Therefore, the connecting member 29 is less likely to incline or move in the axial direction in the piston 21.

The connecting member 29 has a tapered portion 29A having a tapered shape at a portion facing the nut 26. In addition, the nut 26 has a spherical curved surface portion 26A in line contact with the tapered portion 29A. Therefore, pivoting of the nut 26 with respect to the connecting member 29 at the time of generation of the braking force can be realized with a simple structure. Incidentally, since the nut 26 and the connecting member 29 are not always coupled to each other, such a connection structure can be easily applied to a braking device using both electric power and hydraulic pressure.

Note that shift or inclination of the center axes L1 and L2 of the piston 21 and the cylinder 17 may occur due to a machining error or an assembly error at the time of manufacturing. Such shift and inclination of the center axes L1 and L2 caused by the machining error and the assembly error are also factors that cause an unbalanced load in the components of the electric braking device 10. In the electric braking device 10 of the present embodiment, the generation of an unbalanced load due to the shift or inclination of the center axes L1 and L2 caused by the machining error or the assembly error can be similarly suppressed.

Note that the tapered portion 29A of the connecting member 29 is in line contact with the curved surface portion 26A of the nut 26. A high load is locally applied to the tapered portion 29A at the time of generation of the braking force. In the present embodiment, since the material of the connecting member 29 is a steel material, strength to withstand a high load applied at the time of generation of the braking force can be secured. On the other hand, since the piston 21 receives pressing force against the connecting member 29 and the friction member 11B at the surface, the required strength is not as high as that of the connecting member 29. In the present embodiment, since the material of the piston 21 is an aluminum material, it is possible to contribute to weight reduction of the device.

### OTHER EMBODIMENTS

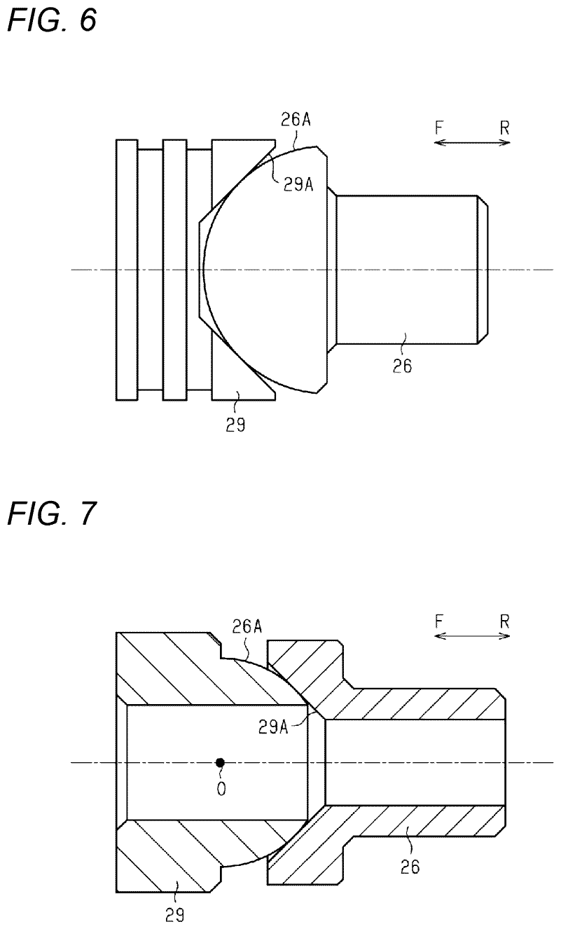

The present embodiment can be modified and implemented as follows. The present embodiment and the following modified examples can be implemented in combination with each other within a technically consistent scope.
As the elastic member 30, a member other than the O-ring such as a leaf spring may be adopted.
For example, as illustrated in FIG. 6, the curved surface portion 26A may have a cylindrical shape, and the tapered portion 29A may have a V-shaped valley shape. In this case, the linear-motion converting mechanism 20 can pivot with one degree of freedom with respect to the connecting member 29. In a case where the manner of deflection of the caliper 13 is determined to a certain extent at the time of generation of the braking force, or the like, the generation of an unbalanced load can be suppressed even with the pivot with one degree of freedom.
In a case where the nut 26 constantly comes into contact with the connecting member 29 to restrict the movement of the connecting member 29 in the axial direction in the piston 21, or the like, the elastic member 30 may be omitted.
For example, as illustrated in FIG. 7, the curved surface portion 26A may be provided on the connecting member 29, and the tapered portion 29A may be provided on the nut 26.
The linear-motion converting mechanism 20 may be configured such that the nut is a rotary member and the screw shaft is a linear motion member. In this case, the tapered portion 29A or the curved surface portion 26A is provided on the screw shaft.
As a structure for enabling the linear motion member to pivot with respect to the connecting member 29, a structure other than the contact between the tapered portion 29A and the curved surface portion 26A, such as a ball joint, may be adopted.
The electric braking device 10 may be configured as a wet electric braking device. A wet electric braking device generates a hydraulic pressure by applying pressing force to a brake fluid introduced into a cylinder by reciprocation of a piston in the cylinder, and generates a braking force using the hydraulic pressure. Even in such a wet electric braking device, the center axis of the piston and the center axis of the cylinder may be inclined due to an external force, a machining error of a component, or an assembly error. Therefore, even in the wet electric braking device, if the connection structure of the piston 21 and the linear motion member by way of the connecting member 29 as described above is adopted, the generation of an unbalanced load of the components can be suppressed.

1. An electric braking device including a piston linearly movably accommodated in a cylinder and being configured to generate a braking force according to linear motion of the piston with rotation of an electric motor as power, the electric braking device comprising:
a linear-motion converting mechanism including a rotary member configured to rotate upon receiving rotation of the electric motor and a linear motion member configured to linearly move according to rotation of the rotary member; and
a connecting member interposed between the linear motion member and the piston to mediate transmission of a pressing force in an axial direction of the cylinder between the linear motion member and the piston;
wherein
the linear motion member is installed to be pivotable with respect to the connecting member, and
the connecting member is installed to be movable in a radial direction of the piston with respect to the piston.

2. The electric braking device according to claim 1, wherein an elastic member is interposed at a portion between the connecting member and the piston in a radial direction of the cylinder.

3. The electric braking device according to claim 1, wherein
one of the connecting member and the linear motion member has a tapered portion formed in a tapered shape at a portion facing the other member, and
the other one of the connecting member and the linear motion member has a cylindrical or spherical curved surface portion that comes into line contact with the tapered portion.
